(19) United States
(12) Patent Application Publication
(10) Pub. No.: US 2016/0004913 A1
(43) Pub. Date: Jan. 7, 2016

(54) APPARATUS AND METHOD FOR VIDEO ANALYTICS

(71) Applicant: ITX SECURITY CO., LTD., Seoul (KR)

(72) Inventor: Sang Yeol PARK, Seongnam-si (KR)

(73) Assignee: ITX SECURITY CO., LTD., Seoul (KR)

(21) Appl. No.: 14/751,500

(22) Filed: Jun. 26, 2015

(30) Foreign Application Priority Data
Jul. 1, 2014 (KR) 10-2014-0082084

(51) Int. Cl. G06K 9/00; G06K 9/46

(52) U.S. Cl. CPC G06K 9/00771; G06K 9/00711; G06K 9/4604

(57) ABSTRACT

An apparatus for Video Analytics (VA), including an object identifier configured to identify an object in a video image, a property extractor configured to extract properties of the object, a property-of-interest designator configured to designate at least some of the extracted properties as properties of interest for identifying a target, and a target recognizer configured to recognize an object identified in a video image as a target in a case where properties of the object are similar to properties of interest.

### CROSS-REFERENCE TO RELATED APPLICATION(S)

This application claims priority from Korean Patent Application No. 10-2014-0082084, filed on Jul. 1, 2014, in the Korean Intellectual Property Office, the entire disclosure of which is incorporated herein by reference for all purposes.

### BACKGROUND

1. Field

The following description relates to a technology for Video Analytics (VA).

2. Description of the Related Art

A system for Video Analytics (VA) partitions a monitor screen into four or eight parts to is display images captured by multiple cameras. If too many cameras are used, images captured by the cameras may be displayed on a plurality of monitors, respectively. By displaying images from multiple cameras on one or more monitor screens, the system for VA may be used as a powerful tool for security staff to monitor the screens and prevent theft or terror. Such systems for VA have been used and regarded very important in many government offices and corporations for recent years. However, it is hard to continuously monitor every screen displaying a different video and this monitoring process highly depends on capabilities of the security staff, so that perfect security cannot be expected. For this reason, a solution is needed, which helps the security staff to be free from a flood of information and provides more airtight security.

Under this circumstance, it is highly required to achieve and implement Intelligent Video Surveillance (IVS). If an IVS system is established as a fully digitalized one, it will provide more powerful performance. It is because a video transmission technique based on an IP network is more flexible than a conventional point-to-point analogue transmission technique. Each camera acts as an intelligent web camera that is able to analyze video data at any point on a communication path and take action for it. In the IVS system, processing video data is beyond capturing, digitalizing, and compressing video data. For instance, Onboard™ software made by ObjectVideo Incorporate has functions of identifying objects and analyzing activities of the objects.

Following are details about the functions of identifying objects and activities thereof. In order to successfully extract security information regarding an object, software needs to have a capability of classifying objects. For instance, the software should be able to identify human, animals, vehicles, and any other objects. Objects are identified by an analytic engine in the software. In addition, the software can identifies activities of an object, and compare the activities with a series of conditions made by the security staff. One example of the conditions may be an intrusion into a security zone.

In the case of a tripwire event, a security staff member may draw a virtual line on a video image using a stylus pen or a mouse to mark a security boundary. This virtual line is called a tripwire. Then, the security staff member may set a condition of a target to detect a tripwire event. For instance, the condition may be a man with red clothes. In this condition, a tripwire event occurs when a man with red clothes passes through the tripwire, and the security staff may notice an intrusion into a security zone. As such, by setting a condition of a target, it is possible to accurately detect a desired event. However, if the man is in red at the top and black in the bottom, it is hard to determine whether the man is a target or it is difficult to set a specific condition. In addition, when the security staff monitor screens with bare eyes, they often depend on their instinct or senses to determine whether a person, a vehicle, or any object is suspicious. However, such sensory criteria are too abstractive and ambiguous, so it is difficult to be set as a specific condition for identifying a target.

### SUMMARY

The following description relates to an apparatus and method for Video Analytics (VA), which make it easier to designate a condition of a target for VA.

In one general aspect, there is provided an Apparatus for Video Analytics (VA) including: an object identifier configured to identify an object in a video image; a property extractor configured to extract properties of the object; a property-of-interest designator configured to designate at least some of the extracted properties as properties of interest for identifying a target; and a target recognizer configured to recognize an object identified in a video image as a target in a case where properties of the object are similar to properties of interest.

The property-of-interest designator may be further configured to designate at least some of properties extracted from an object selected by a user as properties of interest. The property-of-interest designator may be further configured to designate at least some properties selected by a user from among extracted properties as properties of interest.

According to another general aspect, there is provided a method for Video Analytics (VA) comprising: identifying an object in a video image; extracting properties of the object; designating at least some of the extracted properties as properties of interest for identifying a target; and recognizing an object identified in a video image as a target in a case where properties of the object are similar to properties of interest.

Other features and aspects may be apparent from the following detailed description, the drawings, and the claims.

### BRIEF DESCRIPTION OF THE DRAWINGS

FIG. 1 is a block diagram illustrating a system for Video Analytics (VA) according to an exemplary embodiment of the present disclosure.

FIG. 2 is a flowchart illustrating a method for VA according to an exemplary embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

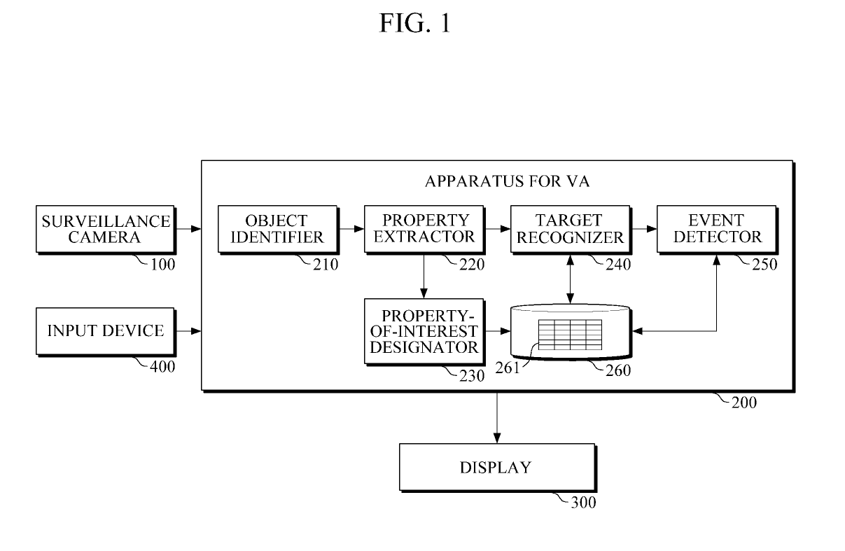

FIG. 1 is a block diagram illustrating a system for Video Analytics (VA) according to an exemplary embodiment of the present disclosure.

Referring to FIG. 1, a system for VA includes a surveillance camera 100 and apparatus 200 for VA. The surveillance camera 100 may be an IP camera embedded with a web server. FIG. 1 shows a case where the system for VA includes a single surveillance camera 100 for convenience of explanation, but the System for VA may include a plurality of surveillance cameras. The apparatus 200 consists of hardware resources, such as a processor and a memory, and VA software implemented by the processor. As illustrated in FIG. 1, the apparatus 200 includes an object identifier 210, a property extractor 220, a property-of-interest designator 230, and a target recognizer 240. The object identifier 210 identifies an object by processing a video image received from the surveillance camera 100. For instance, the object identifier 210 separates a video image into a background and a foreground, and identifies objects only in the background. The objects are any moving entity, such as a human and a vehicle. A technology of identifying an object by extracting a boundary of the object through image processing is well-known knowledge.

The property extractor 220 extracts properties of an object identified by the object identifier 210. For example, if the object is a person, the properties may be height, size, clothe color, type or color of a hat, and moving speed. If the object is a vehicle, the properties may be a big/midsized/small car, a sedan, a truck, a recreational vehicle (RV), speed, and color. The property-of-interest designator 230 may designate some of the properties extracted by the property extractor 220 as properties of interest that are used for identifying a target. The properties of interest may be added to an event condition list 261 stored in a storage 260.

If an object is identified in a video image, the target recognizer 240 determines whether properties extracted from an object identified in a video image are similar to properties of interest. For instance, in the case where properties of interest are “180 cm height & black cloth” and properties of an identified object is “177 cm height & a black series cloth”, the target recognizer 240 determines that the properties of the identified object are similar to properties of interest. However, if any single different property of an object is different, the target recognizer 240 determines that properties of the object are not similar to properties of interest. In the case where no settings are made in advance by a manager or administrator, properties of interest may be designated by default. If it is determined that properties of an object are similar to properties of interest, the target recognizer 240 recognizes the identified object as a target.

In response to detection of movement that satisfies an event condition included in the event condition list 261, the event detector 250 notifies a user that an event has occurred. Examples of an event detection may include tripwire detection, multi-line tripwire detection, loitering detection, and the like. Tripwire detection indicates a case of detecting an object that passes over a virtual tripwire drawn on a video image and moves in a particular direction. Multi-line tripwire detection enables a rule set between two virtual tripwires, for example, detecting how long it takes for an object to pass the second tripwire after the first one. Using multi-line tripwire detection, it is possible to detect an illegal U-turn, traffic flow, or designated speed. Loitering detection indicates a case of detecting a target constantly loitering about a particular place.

According to another aspect, the property-of-interest designator 230 designates at least some properties selected through a user interface as properties of interest. That is, the property-of-interest designator 230 designates only properties selected by a user, not an object's entire properties extracted by the property extractor 220, as properties of interest. For instance, in the case where a user uses an input device 400, such as a mouse, to select a reference object on a display 300, such as a Liquid Crystal Display (LCD), the property-of-interest designator 230 designates some of properties extracted from the selected reference object as properties of interest. To put it simply, if a user selects a reference object while monitoring the screen, at least some properties of the reference object are used as information for identifying a target.

According yet another aspect, the property-of-interest designator 230 designates one or more properties selected through a user interface among entire properties extracted by the property extractors 220 as properties of interest. In one embodiment, the property-of-interest designator 230 may show properties extracted by the property extractors 220 to a user through the display 300. Then, using the input device 400, the user selects one or more of the properties. If at least some of the properties are selected, the property-of-interest designator 230 designates the selected properties as properties of interest so as to update the event condition list 261 stored in the storage 260. The event condition list 261 may contain properties of interest per object. Meanwhile, in the case where no property is selected through a user interface, all properties may be designated as properties of interest by default.

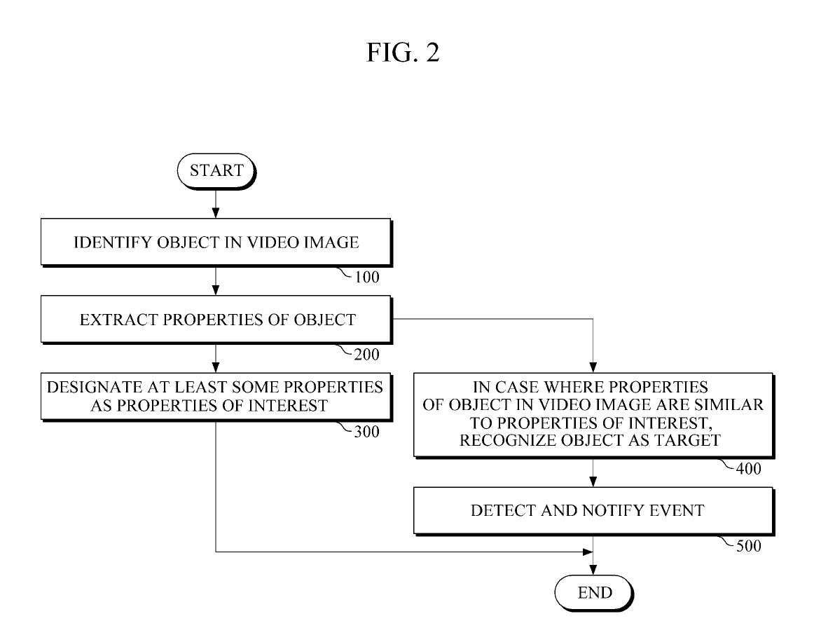

FIG. 2 is a flowchart illustrating a method for VA according to an exemplary embodiment of the present disclosure. FIG. 2 is described in conjunction with FIG. 1. A processor of the apparatus 200 identifies an object in a video image received from the surveillance camera 100 in 100. Once the object is identified, the processor extracts properties of the object in 200. The processor designates at least some of the extracted properties as properties of interest that are used for identifying a target in 300. In operation 300, the processor designates not any properties of the extracted properties, but only user selected properties as properties of interest. In addition, in operation 300, the processor may designate only some properties selected through a user interface from among all the extracted properties as properties of interest. That is, only properties selected by a user are designated as properties of interest.

In the case where properties extracted from an object identified in the video image are similar to properties of interest, the processor recognizes the object as a target in 400. Operation 400 is performed independently from operation 300, and may follow operations 100 and 200. In addition, operation 300 may follow operations 200, or may be performed only when a reference object is selected by a user. After operation 400, in response to detection of movement that satisfies an event condition, the processor notifies occurrence of an event in 500.

The aforementioned apparatus and method for VA make it easy to designate a condition for identifying a surveillance target, so that the surveillance target may be identifying more efficiently and security performance may improve.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An Apparatus for Video Analytics (VA) comprising:
an object identifier configured to identify an object in a video image;
a property extractor configured to extract properties of the object;
a property-of-interest designator configured to designate at least some of the extracted properties as properties of interest for identifying a target; and
a target recognizer configured to recognize an object identified in a video image as a target in a case where properties of the object are similar to properties of interest.

2. The apparatus of claim 1, wherein the property-of-interest designator is further configured to designate at least some of properties extracted from an object selected by a user as properties of interest.

3. The apparatus of claim 1, wherein the property-of-interest designator is further configured to designate at least some properties selected by a user from among extracted properties as properties of interest.

4. A method for Video Analytics (VA) comprising:
identifying an object in a video image;
extracting properties of the object;
designating at least some of the extracted properties as properties of interest for identifying a target; and
recognizing an object identified in a video image as a target in a case where properties of the object are similar to properties of interest.

5. The method of claim 4, wherein the designating comprises designating at least some of properties extracted from an object selected by a user as properties of interest.
